(19) United States
(12) Patent Application Publication
(10) Pub. No.: US 2017/0041359 A1
(43) Pub. Date: Feb. 9, 2017

(54) DEVICE FOR CAPTURING AND STREAMING VIDEO AND AUDIO

(71) Applicant: John Man Kwong Kwan, Sunnyvale, CA (US)

(72) Inventor: John Man Kwong Kwan, Sunnyvale, CA (US)

(21) Appl. No.: 15/227,309

(22) Filed: Aug. 3, 2016

Related U.S. Application Data
(60) Provisional application No. 62/200,170, filed on Aug. 3, 2015.

(51) Int. Cl. H04L 29/06; G06F 3/0488; G06F 3/0484; H04N 7/18; G06F 3/16

(52) U.S. Cl. CPC H04L 65/4069; H04L 65/1059; H04N 7/183; G06F 3/16; G06F 3/04842; G06F 3/0488

(57) ABSTRACT

A portable communications device captures a plurality of data records from a camera and streams the data records to another, external device after detecting a first trigger event and a second trigger event. The portable communications device may initiate streaming of captured data records following detection of only one high confidence trigger event. Data records streamed to an external communications management system are protected from deliberate, inadvertent, or accidental alteration or deletion, thereby protecting the integrity of captured audio and video data. Data records may be stored in a buffer memory in the device when a communications link to an external device is not available, then streamed from the device after a communications link has been established.

### CROSS REFERENCE

This application claims priority to U.S. Provisional Patent Application No. 62/200,170, titled “Device for Capturing and Streaming Video and Audio Data”, filed Aug. 3, 2015, and incorporated herein by reference in its entirety.

### FIELD OF THE INVENTION

Embodiments are related to lightweight, portable video and audio recording devices.

### BACKGROUND

Lightweight, battery-powered video cameras may be carried by police officers, firefighters, military personnel, athletes, and others to capture video and audio records of events, activities, and conditions experienced by a person carrying a camera. A video camera small enough to be worn on a headband, hat, helmet or garment may be referred to as a body camera. Video and audio records may be captured by a body camera or other compact, portable camera for training purposes, documenting a person's actions, data collection and/or analysis of a location, person, or event, as evidence in a legal proceeding, or for other purposes.

After video and possibly audio data has been captured, data may be retrieved from a memory in the camera, or possibly from a memory device connected to the camera, and viewed on a display. Some cameras include a display for viewing images as the images are captured and for reviewing saved images. A camera may be able to transmit video data to another device coupled to the camera with a cable, possibly while the images are being recorded by the camera.

The maximum duration of a video recording may be limited by the amount of data storage coupled to the camera for saving recorded video and audio. When the camera's data storage is filled with captured data, data in the camera may be deleted or overwritten by more recently captured data. The camera may be connected to a data archiving device to offload captured video and audio. Until the captured data is unloaded to another storage device, captured video and audio may be vulnerable to loss, inadvertent alteration, or deliberate manipulation. It may be possible, for example, to unload data from the camera to another device, use the other device to edit or delete some or all of the data, and return the altered data to the camera's memory before the data is transferred to a data archiving system.

Altered or manipulated video and audio data may not accurately represent an event of interest. Other problems may impair the integrity of recorded information. For example, a camera may be lost or damaged, possibly resulting in corruption or irretrievable loss of recorded information stored in the camera's memory. A depleted battery may prevent a camera or audio recording system from operating. A person using a camera may forget to activate the camera or may deliberately avoid activating the camera, possibly resulting in a failure to record important information.

Other problems with data capture and data archiving may occur with cameras that use wired connections to an external device. Examples of external devices that may be connected to a camera include, but are not limited to, a battery pack for supplying electrical power over a cable to the camera, a device connected by an electrical cable to a body camera for receiving images from the camera and possibly retransmitting the images over a network to other devices, and a storage device for saving captured video and audio. External battery packs, external storage devices, and wired connections between the camera and other devices may be vulnerable to damage caused during vigorous physical activity. A cable for establishing connections between an external device and a camera may be damaged or unavailable when needed. A storage device may not be available for cable connection to a camera or may not be within range of a local data communications network for cameras with wireless LAN or Bluetooth(™) capability. Wired connections may be vulnerable to deliberate damage caused by someone attempting to prevent recording from occurring or to destroy already-recorded data before the data can be offloaded to a secure storage system.

### SUMMARY

An example embodiment includes a portable communications device. The example portable communications device includes a central processing unit implemented in hardware; a display in data communication with the central processing unit; a radio transceiver in data communication with the central processing unit; a camera in data communication with the central processing unit; a microphone coupled to the central processing unit; and a memory in data communication with central processing unit. The central processing unit is preferably configured to form streaming data records from signals received from the camera and the microphone and transmit the streaming data records through the radio transceiver after detecting a first trigger event and a second trigger event. The example embodiment further includes a communications management system configured to receive the streaming data records from the portable communications device and store the streaming data records on a data archiving system; and a docking connector connected to the communications management system. The docking connector is preferably configured to connect to the portable communications device and receive the streaming data records.

The example portable communications device may be configured to transmit the streaming data records while capturing data from said camera. The portable communications device may be configured to transmit the streaming data records while capturing data from the microphone.

The portable communications device may further include a graphical user interface. The graphical user interface may include: a start selector for initiating recording and transmission of the streaming data records; a standby selector for saving captured data without transmission of the streaming data records; a data streaming active indicator; and a request assistance selector. The graphical user interface may further include any one or more of a text entry window, an image display window, a video recording selector, and/or an audio recording selector.

The central processing unit may be configured to form streaming data records from signals received from the camera and the microhone and transmit the streaming data records through the radio transceiver after detecting only one high confidence trigger event.

Another example embodiment includes forming a plurality of data records from video images captured by a camera in a portable communication device; detecting a first trigger event with the portable communications device; detecting a second trigger event after the first trigger event with the portable communications device; and after detecting the second trigger event, streaming the plurality of data records from the portable communications device to a communications management system.

### BRIEF DESCRIPTION OF THE DRAWINGS

FIG. 1 shows an example of an embodiment adapted for streaming data records to a communications management system and a data archiving system through a cellular telephone network.

FIG. 2 is a block diagram of an example of a portable communications device (PCD) in accord with an embodiment.

FIG. 3 shows examples of an optional external sensor capable of detecting a trigger event for initiating video and/or audio recording on the PCD.

FIG. 4 shows example data values included in an example data record in accord with an embodiment.

FIG. 5 is a timing diagram illustrating an example of data streaming initiated by one and only one high confidence trigger event.

FIG. 6 is a timing diagram illustrating an example of data streaming initiated by at least two trigger events, and further illustrating an example of pretrigger data.

FIG. 7 illustrates an example PCD and an example graphical user interface (GUI) in accord with the disclosed embodiments.

### DESCRIPTION

An embodiment may capture video and/or audio records of an event with a portable communications device (PCD), save digital data records corresponding to the captured video and audio in a data storage memory, and stream the data records over a wireless data communications network for storage on a data archiving system. Streamed video, audio, and possibly other data may be protected from loss, inadvertent alteration, or deliberate manipulation by being transferred from the PCD to another device, possibly while new video and audio data are being captured. When streaming is unavailable, for example when communications between the PCD and another PCD or an external data archiving system have been interrupted, data may continue to be saved in a nonvolatile memory in the PCD. Streaming may resume automatically when communications are restored.

Streaming refers to transmission of sequential data records from a source device to a destination device over a communications network. Each data record may represent a subset of data collected for an event of interest. Data records may include information which allows a receiving system to save the records in the same time-sequential order as the transmitted from the source device. In contrast to body cameras adapted to save video to a local memory for transfer to an external storage system after recording has been stopped, streaming by an embodiment provides greater recording time, and possibly higher image resolution, than may be achieved with data storage within the recording device alone. Streaming by an embodiment may make it more difficult for captured video and audio to be inadvertently or deliberately altered or deleted.

Embodiments are advantageous for applications in which video recordings and optionally audio recordings are to be made of a person's activities and speech, for example interactions with other people or objects, events witnessed or experienced by the person, actions taken by others, conditions that may affect the person's actions or decisions, and so on. Reviewing and sharing audio and video streamed concurrently with unfolding events may improve situational awareness for decision makers not in attendance at an event of interest and for other personnel preparing to arrive at an event. An event and a data record related to the event are considered to be concurrent when a time interval between the event and the availability of the corresponding data in system where the data may be reviewed is less than five seconds. In some embodiments, the time interval may be less than two seconds.

Video, audio, and other data captured by an embodiment may be used as evidence in a legal proceeding. Image data and audio data saved an embodiment preferably represent an accurate, detailed, unaltered, and uniquely identified record of events of interest. An embodiment providing an accurate and unaltered data record representing an event of interest provides and protects data integrity. Data records captured by an embodiment may be archived on a secure data archiving system before the data are lost, deleted, or altered, either deliberately or inadvertently.

An embodiment may maintain data integrity by streaming captured data records to an external system concurrently with an event being recorded. A PCD may continue to capture audio and video at high resolution for as long as the PCD is turned on. For example, an embodiment may capture and stream high definition (HD) video data without interruption or data loss for a complete twelve-hour duty shift. Streamed data records may be viewed on a communications management system concurrently with an event being captured by a PCD. Capturing images and audio with more than one PCD enables recording and sharing of images, observations, notes, locations, and other data from multiple viewing locations during an event of interest.

The long-duration high resolution recording and streaming capability of an embodiment contrasts with previously known body cameras and other portable audio and video recording devices. In contrast to the disclosed embodiments, a previously known body camera may have a maximum recording time limited by data storage capacity in the camera and may provide recorded audio and video at reduced resolution compared to an embodiment. Important information relating to an event of interest may be missing or obscured in data recorded by previously known equipment. For example, data saved at reduced resolution may make it more difficult to recognize faces or voices captured in video and audio data records.

Data captured while an embodiment is streaming data records to another device may pass through a first-in first-out (FIFO) buffer memory. Data flowing out of the FIFO may be transmitted from the PCD over a communications link to a remote system, preferably with a delay of no more than five seconds between the event being captured and the reception of the corresponding streamed data at the remote system. Streaming may be delayed when a communications link is interrupted but may resume without loss of streamed data records after the link is restored by retrieving data records from the buffer memory and possibly from other memory in the PCD.

An embodiment may perform “live streaming”, where live streaming refers to transmission of a data record from the recording device to a destination device concurrently with an event being recorded. An embodiment may also perform “delayed streaming”, where delayed streaming refers to transmission of stored data records substantially after, for example more than five seconds after, the actual time of occurrence of an event of interest. Delayed streaming may occur when, for example, a communication channel through which data records are being streamed is interrupted and later restored, or when data is recorded before a communications connection has been stablished between a PCD and another communications-enabled system. The maximum time duration of live streaming may be limited by the amount of stored electrical power available for operating the PCD. The maximum duration of delayed streaming may be limited by the PCD's memory capacity for storing data records.

Features of a PCD in accord with an embodiment include a digital camera capable of capturing video images and possibly still images, a central processing unit (CPU) for managing operation of the PCD and communications with other devices, a nonvolatile semiconductor memory for saving data records including captured video, and a communications interface for transferring captured data and possibly other data to an external system. A PCD may be configured to send and receive voice communications and data records over a cellular telephone network, present a graphical user interface (GUI) on a flat panel display such as a liquid crystal display (LCD), and may optionally include a web browser for viewing and interacting with web pages on the Internet. An embodiment may include a smart phone, a laptop computer, a tablet computer, a personal digital assistant, and/or another portable device configured for one or more of the features described above.

A PCD may optionally include a wireless communications transceiver (XCVR) operating in accord with Bluetooth(TM) protocols and/or wifi protocols. The PCD may further include an optional touch input system (TIS) for operating selectors displayed on the LCD and optionally for entering data such as text and numbers selected from a keypad displayed as part of a GUI. A PCD is preferably configured for operation from a battery when another source of electrical power is unavailable. An embodiment is preferably small, light in weight, and rugged enough to be carried or worn by a person engaged in vigorous physical activity.

After an embodiment completes a power-on initialization procedure to activate and configure hardware and software components, data capture may be initiated without further intervention by a person carrying the PCD. Under some circumstances, data capture may be initiated when the PCD detects one and only one high confidence trigger event. Alternatively, a PCD may initiate data capture when at least two trigger events have been detected. Initiating data capture after the detection of a high confidence trigger event, or alternately at least two trigger events, may enable a PCD embodiment to avoid capturing data unless an event of interest has been detected. For example, it may be undesirable to initiate a recording when the user of the recording device sneezes, slams a car door, or drops a set of keys, possibly producing a routine sound loud enough to serve as a single trigger event. Similarly, it may be undesirable to initiate recording when a person walks down a flight of stairs, possibly causing impact transients detectable by an accelerometer in a PCD. There may be many situations where a single trigger event could start unwanted image and sound recording, possibly consuming battery power unnecessarily, filling storage capacity with unwanted data, and increasing labor costs for reviewing captured video and audio to locate important events in the midst of long stretches of unimportant data. This may differ from previously known body cameras, which may fail to record an event of interest when a person carrying the body camera forgets to, or deliberately avoids, activating the camera's record function, and which may record long periods of video in which no event of interest may have been captured.

A single trigger event may be sufficient to initiate data capture by an embodiment, for example when the trigger event is a member of a group of high-confidence trigger events. Examples of high-confidence trigger events include, but are not limited to, a keypress of one or more selected keys on the PCD, selecting with the TIS or a key on a keypad an object displayed on the LCD representing a “start recording now” command, a command to start recording received by a PCD from another device, a sufficiently large signal from at least one of a preferred list of sensors in data communication with a PCD, for example activation of a light bar on a patrol car, a signal from a vehicle's computer that an air bag has deployed, detection of an audio signal corresponding to the discharge of a firearm, and so on.

Detection of at least two trigger events may optionally cause a PCD to initiate data capture. The trigger events may be from different sensors, for example a trigger event from a microphone signal and another trigger event from an accelerometer signal or GPS position data. Or, two trigger events from one sensor may initiate data capture. Two trigger events from different sensors may be concurrent with each other or may alternatively be separated in time from one another. Two trigger events detected by a same sensor are preferably separated in time from one another.

Trigger events may be recognized by a PCD according to the capabilities of the sensors included with or in signal communication with the PCD. An embodiment may include a sensor configured to detect a physical quantity such as, but not limited to, sound, acceleration, light, temperature, motion, vibration, weight, pressure, distance, and other parameters such as direction of motion, geographic location, and physiological parameters such as heart rate or respiratory rate, any of which may be the source of a trigger event for starting data capture and/or data streaming. For example, a microphone or other sound sensor may detect an audio trigger event including, but not limited to, a transient sound from a car crash or other impact, the sound of a gunshot, explosion, breaking glass, or a shout, the start of an emergency siren, the sound of a vehicle door opening or closing, a security system alarm or fire alarm, and so on. Other trigger events may be related to a geographic location, for example but not limited to a sustained stationary position (i.e., no change in location) for a selected time duration, possibly indicating an injured or incapacitated person, a sudden change in position, for example when a person falls or starts running, a rapid change in direction, a GPS location detected within, or alternatively outside of, a predefined geographic area, and so on. Trigger events relating to a measured value of acceleration include, but are not limited to, a magnitude of acceleration greater than a selected threshold value, an impact transient detected by an accelerometer, an abrupt or unexpected deceleration, and so on. A trigger event may be related to a physiological condition of a person in close proximity to an embodiment. Other trigger events may be related to a status of a vehicle or a system in a vehicle, for example engine status, tire pressure, radio turned on or off, fuel status, and so on.

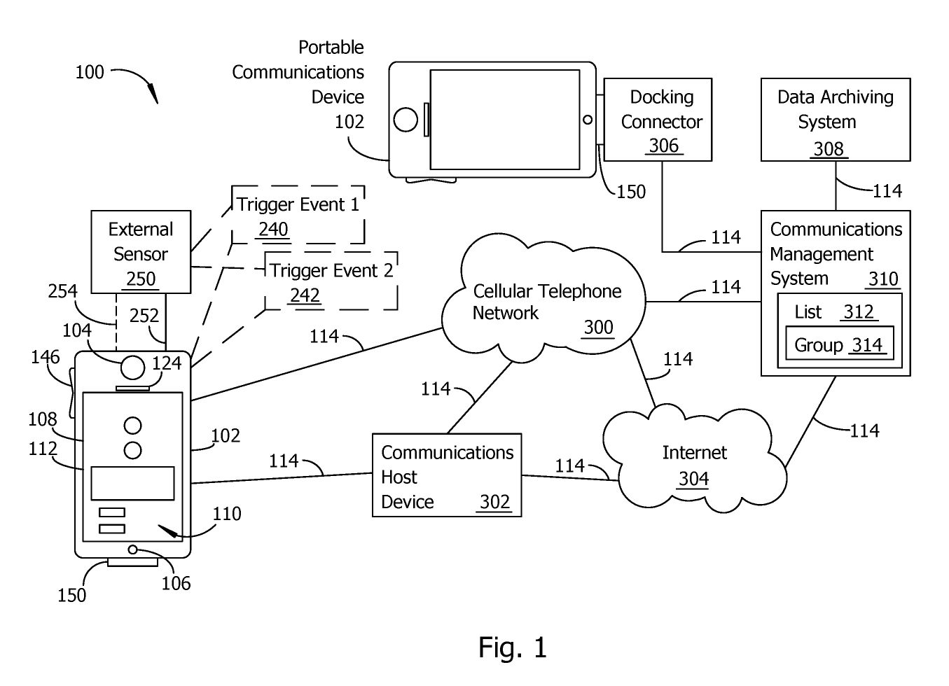

FIG. 1 shows an example embodiment 100 in wireless communication with a remote data archiving system 308 through a cellular telephone network 300. Some embodiments 100 include a PCD 102 having a camera 104 and a liquid crystal display (LCD) 108 capable of presenting a graphical user interface (GUI) 110 representing image and text information arranged as user controls, status indicators, data entry windows, and possibly other graphics and text objects. Some user controls may optionally be implemented as text or graphics objects configured as touch targets for a Touch Input System (TIS) 112. A user control configured as a touch target may be referred to as a selector. Touching a selector on the LCD 108 with a fingertip or stylus may be detected by the TIS. A touch detection and/or coordinates of the detected touch may be reported to a processor in the PCD 102, possibly resulting in a PCD response from the PCD or from an external system. The coordinates of a touch contact may be reported as display row and column numbers or Cartesian coordinates.

An embodiment may monitor internal, and optionally external, sensors while awaiting detection of a trigger event. An embodiment may also monitor the GUI and communications channels for trigger events, for example commands entered by a user of the PCD or commands received over a communications interface. The example embodiment 100 may respond to only one, and in some conditions two trigger events (240, 242) by capturing data records corresponding to images of a scene within the field of view of the PCD's camera 104 and streaming the data records over a cellular telephone network 300 to an external computer system, for example the communications management system 310.

Examples of objects included in some embodiments of the GUI 110 displayed by the LCD 108 include, but are not limited to, selectors and other touch targets, status indicators, images captured by a camera, and text comprising alphanumeric characters and punctuation characters. A touch target may be a displayed representation of a selection to be made by a user using the TIS 112. Examples of a touch input system include, but are not limited to, a resistive touch overlay, a capacitive touch overlay, an infrared TIS, and a surface acoustic wave TIS. A touch input system may optionally be selected to permit a user to select a touch target on the LCD with a finger covered by a glove or with a tool such as a stylus.

The example of a PCD 102 may further include a microphone 106 and an audio speaker 124 for conducting voice communications, an optional user input device 146, and a docking connector 150. Examples of a user input device 146 include, but are not limited to, a momentary switch, a cursor key, a joystick, a mouse, a touchpad, and a key in an alphanumeric keypad. The docking connector 150 may provide electrical connections for charging a battery in the PCD from an external power source and may further provide a wired connection to an external system when the phone couples to the docking connector.

The PCD 102 may receive electrical signals from an external sensor 250 coupled to the phone by a wired connection 252 or by a wireless connection 254. Electrical signals from the external sensor 250, the microphone 106, and other sensors coupled to the PCD 102 may optionally be used to detect a trigger event, individually or in any combination of sensor signals. Following the detection of only one high confidence trigger event 240, and optionally following the detection of two trigger events 242, the PCD embodiment 102 may initiate streaming of data records 114 through the cellular telephone network 300, and optionally through the Internet 304, to a remote communications management system 310. Data corresponding to voice communications may also be sent and received by the PCD 102 through the cellular telephone network 300.

In some embodiments, a PCD 102 may not include cellular network communications capability. For such a device, communications may be conducted with the communications management system 310 or other devices through an intervening communications host device 302. The communications host device 302 may establish a local wifi or Bluetooth(™) link with the PCD and may relay data from the PCD to the cellular telephone network 300 and/or Internet 304. The host device 302 may optionally serve as an alternate, and optionally redundant, communications path for a PCD with cellular communications capability.

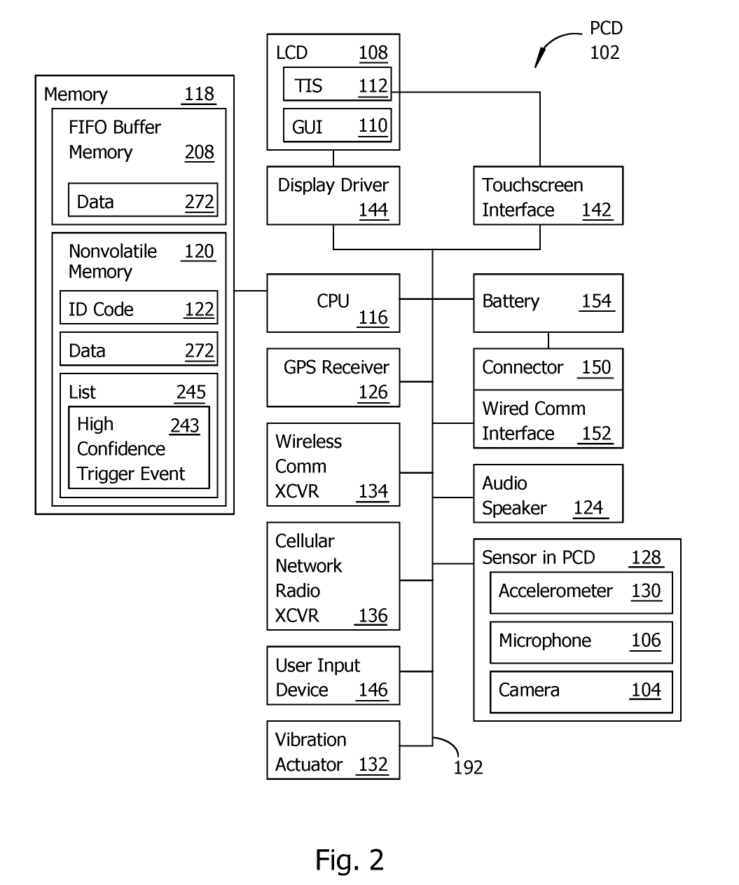

Streaming data records 114 may be received by the communications management system 310 in data communication with the PCD 102 through the cellular telephone network 300 and/or the Internet 304. The communications management system 310 may accept streaming data records 114 from one or more PCD embodiments 102, possibly according to a list 312 including a unique identification code 122 (ref. FIG. 2) assigned to each authorized PCD and/or PCD user. The communications management system 310 may accept streaming data records 114 from and may engage in bidirectional voice and/or data communications with a selected group 314 of PCDs from the list 312. The communications management system 310 may send streaming data records 114 to a data archiving system 308 for secure storage, and may selectively stream data records to other PCDs 102 so more than one person may receive and review recorded data concurrently with an event of interest. The communications management system may include at least one docking connector 306 for transferring data records to and from one or more PCDs 102 by a direct, wired connection through the docking connector 150 on each PCD.

Data capture by a PCD embodiment 102 may be initiated without a trigger event having previously been detected when the phone receives a capture command transmitted through the cellular telephone network 300 from the communications management system 310. The communications management system 310 may, for example, direct every PCD embodiment 102 near an event of interest to immediately begin data capture and streaming of data records, or may alternatively direct a selected group of PCD embodiments to initiated data capture and streaming.

FIG. 2 is a block diagram of example subsystems included in some PCD embodiments 102. A central processing unit (CPU) 116, in some embodiments a CPU implemented in hardware, saves and retrieves data records 272 stored in a memory 118, possibly in first-in, first-out (FIFO) order. The capacity of the memory 118 may optionally be determined by a selected number of minutes of video and/or audio data to be saved should streaming be unavailable. Part of the memory 118 may be organized as a FIFO buffer memory 208 capable of holding at least one, and in some embodiments many data records 272. Data records 272 may optionally be saved in a nonvolatile memory 120 in the PCD to guard against data loss when communications with an external data archiving system are interrupted. An ID code 122 may optionally be stored in the nonvolatile memory 120 to enable the example communications management system 310 to recognize authorized devices from the list 312 and possibly to conduct communications with a selected group 314 of authorized devices only.

The CPU 116 may communicate with a display driver 144 over power and/or data connections 192 for presenting text, images, and graphics for a GUI 110 on the LCD 108. The CPU 116 may send commands to and receive geographic location and optionally accurate local civil time information from a global positioning system (GPS) 126 receiver in the PCD 102. The CPU 116 may accept a user input from at least one user input device 146 and may alert the user to detection of a trigger event, incoming voice and/or data, PCD status, and other information by activating a vibration actuator 132.

The CPU may receive touch coordinates from the TIS 112 on the LCD 108 through a touchscreen interface 142. Touch coordinates may be used to determine which selector in the GUI 110 has been chosen by a user of the PCD 102.

The CPU 116 may exchange data records with devices external to the PCD 102 through any one or more of a cellular network radio transceiver (XCVR) 136, a wireless communications transceiver 134, and a wired communications interface 152. The wired communications interface 152 may be coupled to a docking and/or recharging connector 150. The connector 150 may be electrically connected to a battery 154 for charging the battery. Redundant communications may be implemented by transferring data over more than one communications medium (136, 134, 152).

Audio output, for example voice communications, status and alarm sounds, key press confirmation, audio data records retrieved from memory 118, and so on, may be directed to an audio speaker 124.

The PCD 102 preferably includes at least one sensor 128 configured to detect a trigger event. Examples of a sensor 128 in the PCD include, but are not limited to, a microphone 106, a camera 104, and an optional accelerometer 130. The accelerometer 130 may be used to detect trigger events such as impact transients, changes in direction, and changes in velocity. In addition to its conventional use for voice communications, the microphone 106 may be used to detect audio trigger events. The camera 104 may be used to detect motion or may be used for facial recognition or other image-based trigger events.

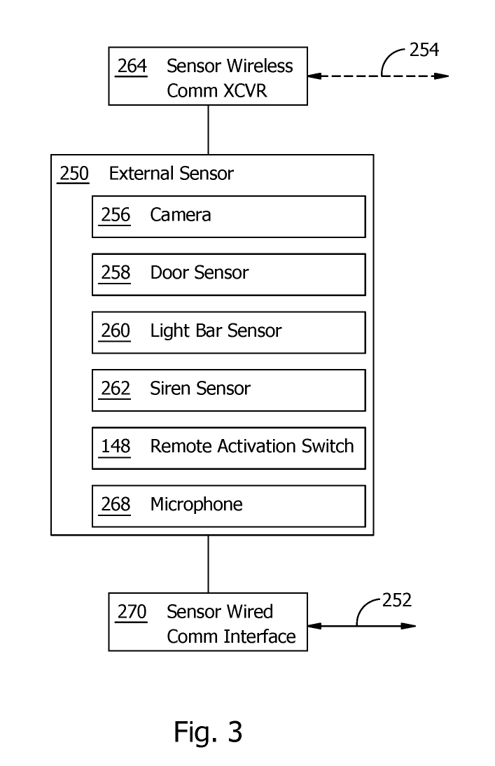

As suggested in FIG. 1 and FIG. 2, a trigger event (240, 242) may be detected by a sensor 128 in the PCD 102 and/or by an external sensor 250 in data communication with the PCD 102. FIG. 3 shows examples of an external sensor 250, including, but not limited to, a camera 256 separate from the camera 104 in the PCD 102, a door sensor 258 in a vehicle, a sensor 260 for detecting when a light bar on an emergency vehicle has been activated, a sensor 262 for detecting when a siren on an emergency vehicle has been activated, a microphone 268, and one or more remote activation switches 148. Examples of a camera 256 include, but are not limited to, a “point of view” (POV) camera clipped to a person's clothing, eyewear, or headgear, a dashboard camera positioned to view a scene outside a vehicle from inside the vehicle, and a camera facing toward the seats in the passenger compartment. Examples of a remote activation switch include a button on a key fob with a radio transmitter, a switch on the dashboard of a vehicle, and the like. A remote activation sensor 250 may optionally communicate with the PCD 102 over a sensor wireless communications transceiver 264 or alternatively over a wired communications interface 270.

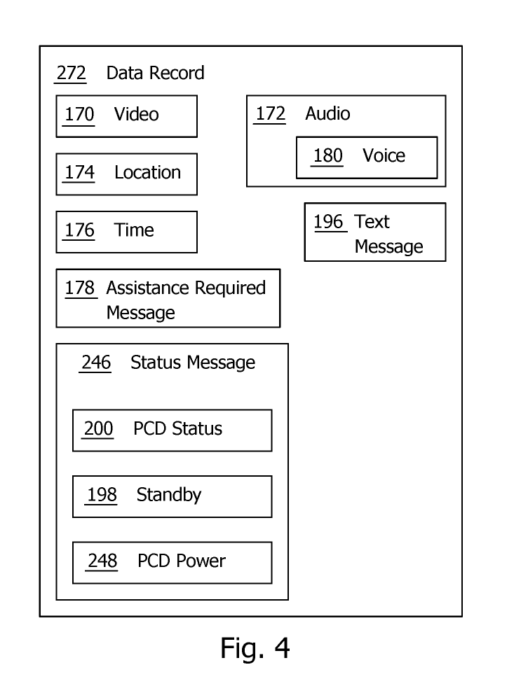

FIG. 4 shows some examples of data saved in a data record which may be streamed from a PCD 102. The example data record 272 may be, for example, a block of data included in the streaming data records 114 from FIG. 1. Examples of a data record 272 include, but are not limited to, data representing video 170 of an event, captured audio 172, possibly including voice communications data 180, a time value 176, possibly a start time for a video or a time marker for an event of interest in a video, a geographic location 174 from the GPS 126, a text message 196, and an assistance required message 178. An assistance required message 178 may be transmitted with high priority and may initiate other actions in the PCD 102.

Continuing with FIG. 4, the example data record 272 may include a status message 246. Examples of a status message 246 include, but are not limited to, a PCD status 200, for example a representation of battery charge, an indication of an operating fault condition or a subsystem or software failure, and so on. Other examples of a status message include a standby status 198. The standby status message 198 may indicate data capture was delayed by placing the PCD in standby mode. The data record 272 may further optionally include a PCD Power message 248 to indicate that a power on/off selector has been operated to turn the PCD off. A person using the PCD may be contacted to turn the unit back on if activation of a power off switch or selector has been reported to the communications management system.

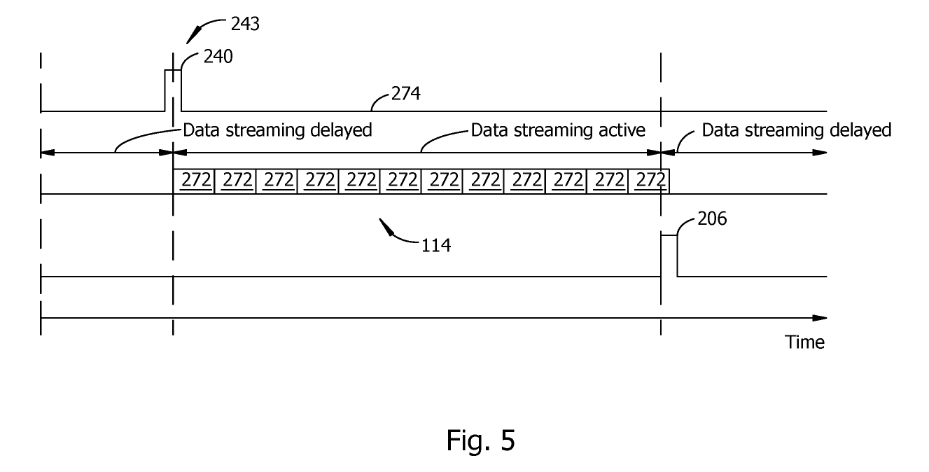

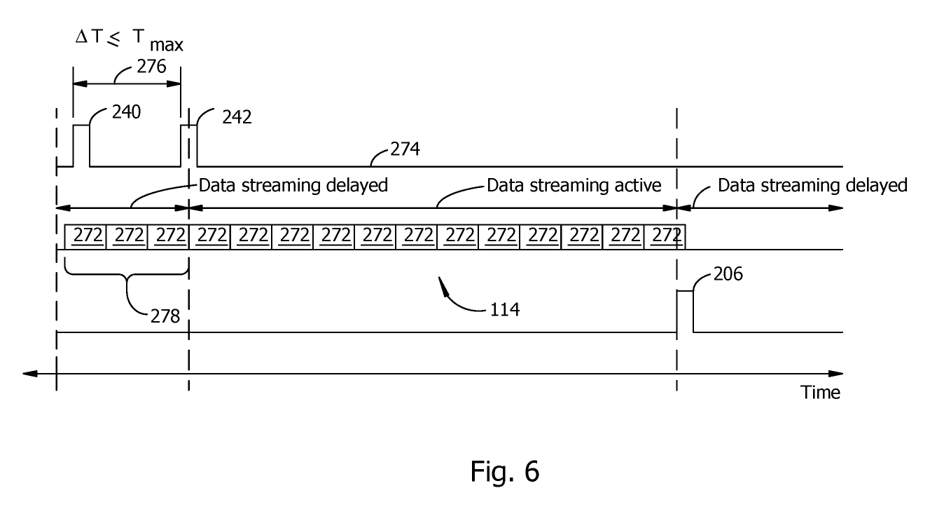

FIGS. 5 and 6 show examples data streaming initiated by a trigger event. In the example of FIG. 5, one trigger event 240 detected in a monitored signal 274 from a sensor in the PCD, or alternately a signal from an external sensor in data communication with the PCD, initiates data capture and data streaming 114. When data capture and/or streaming are initiated from one trigger event, the trigger event is preferably a high-confidence trigger event 243. A list of high confidence trigger events 243 may be stored in the memory 118 of a PCD 102. A high confidence trigger event corresponds to an event which has been judged to be sufficiently important to justify immediate capture and streaming of data records from the PCD. Examples of a high confidence trigger event include, but are not limited to, activation of a light bar on a vehicle, activation of a siren, detection of an air bag deployment, detection of a large transient by an accelerometer in a PCD, possibly relating to the impact of a projectile or a car crash, a sound having a signal amplitude in excess of a preset threshold value, a sound having the acoustic characteristics of a gunshot, and so on.

Streaming data 114 includes at least one, and generally many, sequentially transmitted data records 272. Data streaming may be delayed until the high confidence trigger event is detected, or alternatively until two trigger events are detected, and may continue until a standby command 206 is asserted or a communications link to an external device is interrupted. Transmission of any data record 272 in process of being streamed when the standby command is asserted may be completed before streaming is delayed. A partially transmitted record may optionally be retransmitted after streaming resumes. Transmission of a data record 272 may be repeated if a communications error is detected by either the PCD or by a system receiving the data record.

FIG. 6 shows an example of data streaming initiated by at least two trigger events. Data capture may be performed continuously or may begin upon detection of a first trigger event 240 and a second trigger event 242. The second trigger event 242 may initiate data streaming 114 of data records 272. Data streaming 114 preferably continues until a standby command 206 is received by the PCD 102.

Before detection of the second trigger event 242 in the monitored sensor signal 274, data streaming and data capture may both be delayed. Alternatively, detection of the second trigger event 242 may cause a selected number of records captured before the second trigger to be streamed. Data captured before a trigger event may be referred to as pretrigger data records 278. Pretrigger data 278 may optionally be streamed for single trigger events, for example high confidence events as described for the example of FIG. 5.

Continuing with the example of FIG. 6, after detection of a first trigger event 240, an interval timer may be started to measure a time interval ΔT 276. Data streaming may be initiated when a second trigger 242 is detected before ΔT exceeds a maximum time interval value Tmax. If the second trigger occurs with ΔT greater than Tmax, data streaming, and possibly data capture, may be delayed and the interval timer reset to zero. The timer may optionally be reset to zero whenever the PCD enters standby mode, for example when a Standby command is accepted by the PCD 102 or when a trigger is not received with ΔT less than or equal to Tmax.

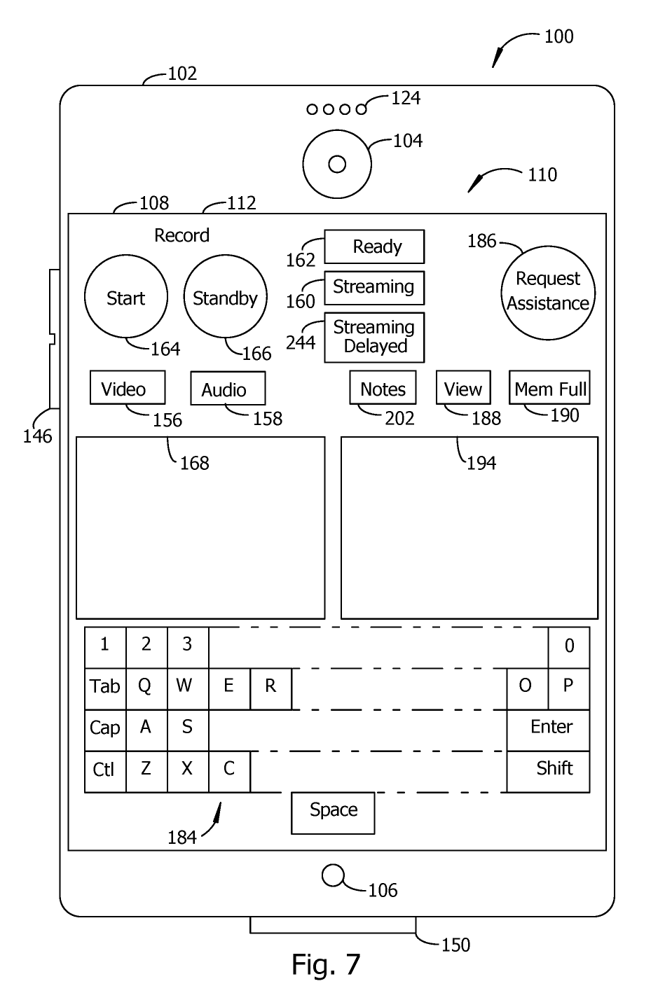

FIG. 7 shows an example of a GUI 110 for a PCD 102 in accord with an embodiment 100. It will be appreciated that many possible alternative configurations of the GUI 110 are possible. Such alternative configurations are considered to be within the scope of the embodiments described herein. The example of a GUI 110 may be displayed on the LCD 108. A TIS 112 enables user selection of touch targets on the LCD 108, each touch target corresponding to a selector for an operating command or data input to the PCD 102. A Ready status indicator 162 may optionally be provided to indicate when the PCD embodiment 102 is ready for data capture. A Streaming status indicator 160 may optionally be provided to indicate that a wireless communications link has been established to a remote system for data streaming, for example a link to the communications management system 110. The Streaming status indicator 160 may provide a visual indication that data records are actively streaming from the PCD 102. A Streaming Delayed indicator 244 may be provided to indicate that streaming has been interrupted and data captured since streaming was interrupted is being stored locally within the PCD 102.

Pressing a Start selector 164 may immediately initiate data capture by the PCD embodiment 102 even when no other trigger event has previously been detected. Pressing a Standby selector 166 may halt data capture and streaming until the Start selector 164 is depressed, a record command from a remote system has been received, or at least one trigger event may have been detected by the PCD embodiment 102. An optional Video indicator 156 may be displayed to show video recording is being performed. An optional Audio indicator 158 may be displayed to show audio recording is being performed. Either one or both of the Video 156 and Audio 158 indicators may optionally function as selectors to enable and disable audio and/or video capture. The communications management system 310 may optionally send an instruction to the PCD 102 to re-enable a disabled recording mode.

An embodiment 100 may optionally include a Request Assistance selector 186. Pressing the Request Assistance selector 186 may immediately initiate video and audio data capture and data streaming to a remote system such as the communications management system 310 or another PCD embodiment 102. Data streamed from the PCD embodiment 102 after Request Assistance has been selected may include data relating to location 174, time 176, video 170, and audio 172, to help remote personnel understand the situation of the person who pressed the Request Assistance 186 selector.

Other optional selectors may be included in the example GUI 100. Pressing an optional Notes selector 202 may activate a text entry and/or display window 168, enabling a user of the PCD embodiment to enter text into the window 168 with a keypad 184. Notes entered by a user may optionally be associated with a particular video data record or group of video data records. A user may record notes as an audio file to be transmitted as audio data with other data records streamed from the PCD 102. The keypad 184 may be implemented as an array of electrical switches on the PCD or as touch targets in the GUI. Text in the window 168 may optionally be associated with a still image or video image presented in an image display window 194. Text messages received from other systems may be viewable in the text window 168. A text message may be time-stamped by including data representing the time the text was entered into the PCD. A time-stamped text message may be displayed automatically at the corresponding time in an audio or video recording being played back.

The image display window 194 may display images from the camera 104 in the PCD embodiment 104, either live images or images retrieved from memory, images from another PCD embodiment, images from a remote camera (ref. camera 256 in FIG. 3), images transmitted from the communications management system, and possibly images from other sources. An optional memory full (Mem Full) indicator 190 may be provided to alert a user that the PCD's internal memory for data records is filled to capacity and the memory must be emptied by streaming data records to another system or offloading records by docking the PCD to another system. An option View selector 188 may be provided to control viewing of images being streamed from the PCD 102, images retrieved from memory, and/or images received from another device such as another PCD or a remote computer system.

Another example embodiment includes steps in a method. The example method embodiment includes forming a plurality of data records from video images captured by a camera in a portable communication device; detecting a first trigger event with the portable communications device; detecting a second trigger event after the first trigger event with the portable communications device; and after detecting the second trigger event, streaming the plurality of data records from the portable communications device to a communications management system.

The example method may further include configuring the communications management system to receive the streamed plurality of data records only from a portable communications device having an identification code stored in a list on the communications management system.

The example method may further include sending the streamed plurality of data records to another of the portable communications device having an identification code stored in a list on the communications management system.

The example method may further include: detecting a high confidence trigger event with the portable communications device; and after detecting the high confidence trigger event, streaming the plurality of data records from the portable communications device to the communications management system.

The example method may further include: forming a plurality of data records from sounds captured by a microphone in the portable communication device; and after detecting the second trigger event, streaming the plurality of data records from the portable communications device to a communications management system.

The example method may further include: measuring a time interval from the first trigger event to the second trigger event; comparing the time interval to a maximum time value; and when time interval is less than the maximum time interval, streaming the plurality of data records from the portable communications device.

The example method may include transmitting data records captured before the second trigger event with the plurality of data records streamed from the portable communications device.

The example method may further include monitoring a signal from a sensor external to the portable communications device and detecting one of the first and second trigger events from the monitored signal.

The example method may further include streaming the plurality of data records after selection of a Start selector in a graphical user interface on the portable communications device.

The example method may further include streaming the plurality of data records after the portable communications device receives a capture command transmitted from the communications management system.

The example method may further include storing the plurality of data records in a memory in the portable communications device until a communications link to an external system is established; and streaming the stored plurality of data records after the communications link is established.

Unless expressly stated otherwise herein, ordinary terms have their corresponding ordinary meanings within the respective contexts of their presentations, and ordinary terms of art have their corresponding regular meanings.

What is claimed is:

1. An apparatus, comprising:
a portable communications device, comprising:
a central processing unit;
a display in data communication with said central processing unit;
a radio transceiver in data communication with said central processing unit;
a camera in data communication with said central processing unit;
a microphone coupled to said central processing unit; and
a memory in data communication with said central processing unit,
wherein said central processing unit is configured to form streaming data records from signals received from said camera and said microphone and transmit said streaming data records through said radio transceiver after detecting a first trigger event and a second trigger event;
a communications management system configured to receive said streaming data records from said portable communications device and store said streaming data records on a data archiving system; and
a docking connector connected to said communications management system, said docking connector configured to connect to said portable communications device and receive said streaming data records.

2. The apparatus of claim 1, wherein said portable communications device is configured to transmit said streaming data records while capturing data from said camera.

3. The apparatus of claim 1, wherein said portable communications device is configured to transmit said streaming data records while capturing data from said microphone.

4. The apparatus of claim 1, said portable communications device further comprising a graphical user interface, said graphical user interface comprising:
a start selector for initiating recording and transmission of said streaming data records;
a standby selector for saving captured data without transmission of said streaming data records;
a data streaming active indicator; and
a request assistance selector.

5. The apparatus of claim 4, said graphical user interface further comprising a text entry window.

6. The apparatus of claim 4, said graphical user interface further comprising an image display window.

7. The apparatus of claim 4, said graphical user interface further comprising a video recording selector.

8. The apparatus of claim 4, said graphical user interface further comprising an audio recording selector.

9. The apparatus of claim 1, wherein said central processing unit is configured to form streaming data records from signals received from said camera and said microphone and transmit said streaming data records through said radio transceiver after detecting only one high confidence trigger event.

10. A method, comprising:
forming a plurality of data records from video images captured by a camera in a portable communication device;
detecting a first trigger event with the portable communications device;
detecting a second trigger event after the first trigger event with the portable communications device; and
after detecting the second trigger event, streaming the plurality of data records from the portable communications device to a communications management system.

11. The method of claim 10, further comprising configuring the communications management system to receive the streamed plurality of data records only from a portable communications device having an identification code stored in a list on the communications management system;

12. The method of claim 10, further comprising sending the streamed plurality of data records to another of the portable communications device having an identification code stored in a list on the communications management system.

13. The method of claim 10, further comprising:
detecting a high confidence trigger event with the portable communications device; and
after detecting the high confidence trigger event, streaming the plurality of data records from the portable communications device to the communications management system.

14. The method of claim 10, further comprising:
forming a plurality of data records from sounds captured by a microphone in the portable communication device; and
after detecting the second trigger event, streaming the plurality of data records from the portable communications device to a communications management system.

15. The method of claim 10, further comprising:
measuring a time interval from the first trigger event to the second trigger event;
comparing the time interval to a maximum time value; and
when time interval is less than the maximum time interval, streaming the plurality of data records from the portable communications device.

16. The method of claim 10, further comprising including data records captured before the second trigger event with the plurality of data records streamed from the portable communications device.

17. The method of claim 10, further comprising monitoring a signal from a sensor external to the portable communications device and detecting one of the first and second trigger events from the monitored signal.

18. The method of claim 10, further comprising streaming the plurality of data records after selection of a Start selector in a graphical user interface on the portable communications device.

19. The method of claim 10, further comprising streaming the plurality of data records after the portable communications device receives a capture command transmitted from the communications management system.

20. The method of claim 10, further comprising:
storing the plurality of data records in a memory in the portable communications device until a communications link to an external system is established; and
streaming the stored plurality of data records after the communications link is established.
